(19) United States
(12) Patent Application Publication
(10) Pub. No.: US 2016/0371747 A1
(43) Pub. Date: Dec. 22, 2016

(54) ADVERTISEMENT SPACE AUCTION ALLOWING FOR SECONDARY AUCTIONS

(71) Applicant: AppNexus, Inc., New York, NY (US)

(72) Inventors: Arel Ives Lidow, New York, NY (US); Charles Brian O'Kelley, New York, NY (US)

(21) Appl. No.: 14/746,288

(22) Filed: Jun. 22, 2015

(51) Int. Cl. G06Q 30/02

(52) U.S. Cl. CPC G06Q 30/0275

(57) ABSTRACT

Methods, systems, and apparatus, including computer programs encoded on a computer storage medium, for receiving a notification of an ad space of a first seller, determining a first arrangement with the first seller for purchasing the ad space, determining a second arrangement with a second seller for purchasing a package comprising the ad space and data associated with the ad space, sending to bidders a bid request comprising a first identifier for the first arrangement and a second identifier for the second arrangement, receiving, from the bidders, bids in response to the bid request, each bid comprising a respective bid price and buyer, and at least one of the first and second identifiers, and selecting, from the received bids, a bid on the package as indicated by the second identifier of the selected bid and causing a creative from the selected bid's buyer to be served to the ad space.

### BACKGROUND

This specification relates to online advertising and, more particularly, ad space auctions.

Online display advertising delivers promotional messages to consumers by using visual advertisements (or “ads”) in web pages. A publisher of a web page can insert an ad space in a web page. An ad space is a region of a web page (or other electronic document) where an advertisement can be placed. When the web page is displayed in a browser, a visual advertisement (a “creative”) of an advertiser can be dynamically retrieved from an ad server for the advertiser, and displayed in the ad space. The act of serving a creative on a web page for displaying is often referred to as an impression.

An ad space inventory is a collection of one or more ad spaces on web pages served by a publisher's web sites. Publisher can sell their ad space inventories to advertisers. Multiple publishers and multiple advertisers can participate in auctions in which selling and buying of ad space inventories take place. Auctions can be conducted by an ad network or ad exchange that brokers between a group of publishers and a group of advertisers.

Selling and buying ad spaces can be based on pricing or payment models such as cost per thousand impressions (CPM), cost per click (CPC), and cost per action or acquisition (CPA). In the CPM model, advertisers typically pay for every impression of their advertisement; the price paid for each impression is measured in price per 1000 (“mille”) impressions. In the CPC model, advertisers typically pay each time a viewer clicks on their advertisement. In the CPA model, advertisers pay for every action, such as a sale or registration, completed as a result of a viewer clicking on their advertisement.

### SUMMARY

In general, one aspect of the subject matter described in this specification can be embodied in methods that include the actions of performing by an auction system, receiving a notification of an ad space, the ad space being part of an ad space inventory of a first seller, the ad space being for presentation in a user interface of an application executing on a client device of a user, determining a first preexisting arrangement with the first seller, the first preexisting arrangement comprising a first floor price for purchasing the ad space, determining a second preexisting arrangement with a second seller, the second preexisting arrangement comprising a second floor price for purchasing a package, the package comprising the ad space and data associated with the ad space, sending a bid request to one or more bidder systems, the bid request comprising a first identifier for the first preexisting arrangement and a second identifier for the second preexisting arrangement, receiving, from one or more of the bidder systems, bids in response to the bid request, each bid comprising a respective bid price, a respective buyer, and at least one of the first and second identifiers, and selecting, from the received bids, a bid on the package as indicated by the second identifier of the selected bid and, based thereon, causing a creative from the selected bid's buyer to be served to the ad space and storing: a first transaction between the first seller and the second seller, and a second transaction between the second seller and the selected bid's buyer. Other embodiments of this aspect include systems, apparatus, and computer programs.

These and other aspects can optionally include one or more of the following features. The first transaction can further comprise a first transaction price payable to the first seller by the second seller, the first transaction price being based on the selected bid's bid price. The second transaction can further comprise a second transaction price payable to the second seller by the selected bid's buyer, the second transaction price being based on the selected bid's bid price. The selected bid's bid price can satisfy the second floor price. The data associated with the ad space can comprise data associated with the user. The data associated with the user can comprise user segment data or user behavioral data. The data associated with the ad space can comprise contextual data of the user interface. The bid request further can comprise at least one of an identifier of the ad space, a size of the ad space, an identifier of the application or a web page including the ad space, an identifier of the user, and an identifier of the client device.

Particular implementations of the subject matter described in this specification can be implemented to realize one or more of the following advantages. The system described herein provides functionality of ad space auctions that allow for secondary auctions. The system allows a reseller to combine an ad space with data associated with the ad space in a package deal. The system conducts an auction on the ad space and the package deal at the same time. If a buyer won the auction on the package deal, the system records two transactions. One transaction is between the buyer and the reseller. The other transaction is between the reseller and the ad space's publisher. Since the system conducts the auction and records the two transactions at the same time, the reseller can sell the ad space and the data associated with the ad space with a margin, without acquiring the ad space in advance. The reseller thus is not exposed to the risk of purchasing and holding on to the ad space but without being able to resell the ad space.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for ad space auctions.

FIG. 2 is a data flow diagram of an example method for ad space auctions.

FIG. 3 is a flowchart of another example method for ad space auctions.

Like reference numbers and designations in the various drawings indicate like elements.

### DETAILED DESCRIPTION

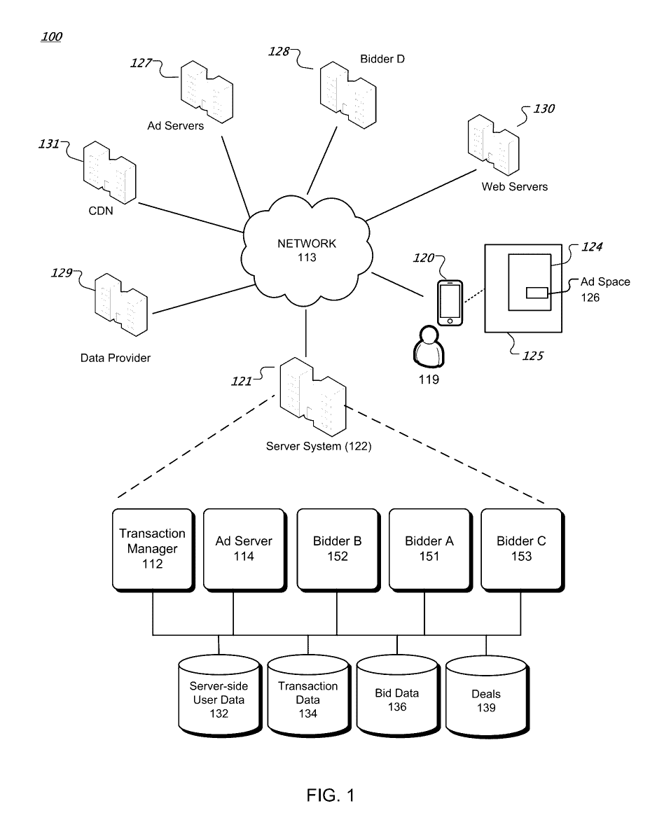

FIG. 1 illustrates an example system 100 for ad space auctions. A server system 122 provides functionality for real-time ad space data packaging and auctions. The server system 122 comprises software components and databases that can be deployed at one or more data centers 121 in one or more geographic locations, for example. The server system 122 software components comprise a transaction manager 112, ad server 114, and one or more bidders (e.g., bidder A 151, bidder B 152, and bidder C 153). The server system 122 can also include one or more software components for load balancing tools and security tools. The load balancing tools manage traffic within a single data center or between multiple data centers. The security tools manage data protection and access privilege for tenants served by the data centers 121. The software components can comprise subcomponents that can execute on the same or on different individual data processing apparatus. The server system 122 databases comprise a server-side user data database 132, transaction data database 134, bid data database 136, and deals database 139. The databases can reside in one or more physical storage systems. The software components and databases will be further described below.

The transaction manager 112 (“impression bus” or simply “Imp Bus”) is an auction system that facilitates the transaction aspects of ad space inventory and impression trading between buyers and sellers. A buyer can be an advertiser (e.g., a credit card company, a sportswear company), an ad network, or an advertising agency, for example. Other buyers are possible. A seller can be a publisher (e.g., newspaper or social network), an online streaming or gaming service, or an ad network. Other sellers are possible. The transaction manager 112 processes ad requests received from web browsers or other software applications displaying content from publishers, sends relevant information to advertisers, conducts auctions (e.g., on behalf of sellers), returns creatives to the browsers or other applications, keeps track of billing and usage for advertisers and publishers, returns auction-result data, and enforces quality standards, for example. The transaction manager 112 stores in the transaction data database 134 various transaction information for each ad space that is transacted by the transaction manager 112 or other software components of the server system 122.

The ad server 114 is a software component that serves creatives to web pages or other applications. The ad server 114 can also make decisions about what creatives to serve, and track clicks or other user interactions with creatives, for example. A creative can be a visual or audio advertisement such as an image, an animation, a video clip, or an audio clip. Other types of a creative are possible.

A bidder system or bidder (e.g., bidder A 151) is a software component that, on behalf of a buyer, performs bidding operations. The bidder takes various pieces of bid-specific information (e.g., maximal bid price, target user areas or segments, start and end dates, budget) as input and generates a bid for a particular item of an ad space inventory, for example. A buyer can set up (e.g., through an API or web pages provided by the server system 122) a campaign targeting an ad space inventory with a set of bid-specific information for the ad space inventory and store the bid-specific information in bid data database 136. In some implementations, a bidder can be remote from the server system 122, such as bidder D 128. Here, an ad space inventory can be a collection of one or more ad spaces on web pages served by a publisher's web site. An ad space inventory can also be a collection of one or more ad spaces in user interfaces presented by a software application published by a publisher. Other collections of ad spaces of an ad space inventory are possible.

The transaction manager 112 conducts an auction when receiving an ad request for filling an available ad space. By way of illustration, a graphical user interface 124 of a software application 125 executing on client device 120 of a user 119 can include an ad space 126 and a corresponding ad tag. The application 125 can be a web browser application, or a software application such as a game application or a maps application. For instance, a web page displayed in a browser window of a web browser (e.g., running on a personal computer) can include an ad space on the web page and a corresponding ad tag. By way of illustration, the ad space can appear at the bottom of the user interface (a “banner ad”) with a corresponding ad tag. Other examples of ad spaces are possible. Here, the client device 120 can be a mobile phone, a smartwatch, a tablet computer, a personal computer, a game console, or an in-car media system. Other examples of a client device are possible.

In some implementations, an ad tag comprises a Uniform Resource Locator (URL) from which an ad will be requested (e.g., a URL for the server system 122), Hypertext Markup Language (HTML) statements and/or JavaScript instructions for retrieving and displaying a creative (e.g., displaying the creative in a 160×600 iframe). The application 125 running on the client device 120 can retrieve content in the user interface 124 (e.g., a web page) through one or more data communication networks 113 such as the Internet, for example, from web servers 130 of a publisher. The ad tag causes the application 125 to send (e.g., through the networks 113) an ad request (“ad call”) to the server system 122. In some implementations, the application 125 sends an ad request to the server system 122 via another advertising server system such as an ad exchange. The ad request can include information about the available ad space 126 (e.g., a size for the ad space, an identifier for the publisher), user information (e.g., an identifier of the user 119, an Internet Protocol or IP address), and system information (e.g., types of the browser and the client device), for example. The ad request can be composed in JavaScript Object Notation (JSON) or Extensible Markup Language (XML) format and transmitted to the server system 122 using Hypertext Transfer Protocol (HTTP) protocol (e.g., using HTTP POST request method). Other ad request formats and transmission methods are possible.

In response to the ad request, the transaction manager 112 generates a bid request including information about the ad space, the user, and so on, and sends the bid request to multiple bidders such as bidder A 151 and bidder B 152. The transaction manager 112 can also send the bid request through the networks 113 to servers of bidder D 128, which is external to the server system 122. The bid request can be composed in JSON format and sent to bidders using HTTP POST. The bid request can also be encoded or compressed. Other bid request formats and transmission methods are possible.

Each bidder can determine an appropriate bid based on its own requirements (e.g., budget, targets in placements) and submit a bid response including a bid price and an identifier of a creative to be served, for example, to the transaction manager 112 (or not to respond at all). The transaction manager 112 determines a winning bid (e.g., a highest bid) among bid responses received within a specified time period (e.g., 100 milliseconds). The transaction manager 112 then returns a creative of the winning bid to the client device 120, causing the application 125 to display the creative in the ad space in the user interface 124. The transaction manager 112 can also return a URL for a creative of the winning bid to the client device 120, causing the application 125 on the client device 120 to retrieve the creative from an ad server (e.g., ad server 114, or ad servers 127 external to the server system 122), or from servers of a content distribution network (CDN) 131. In various implementations, the transaction manager 112 can store in the transaction data database 134 transaction information such as an identifier of the creative served to the ad space, an identifier of the winning buyer, the user's identifier, the winning bid price, an identifier of the ad space, an identifier of the seller of the ad space, and a time stamp. The winning bid price (i.e., the price paid by the winning buyer) can be the bid price submitted by the winning buyer, or a second highest bid price of the auction as determined by Vickrey auction or other second-price auction mechanisms. Other transaction information of a transaction is possible.

A seller can negotiate with a buyer and reach an agreement or arrangement on pricing or other terms on an ad space inventory available from the seller. The seller or the buyer can create (e.g., through an API or a web page provided by the server system 122) a deal (e.g., implemented as a data object) for the agreed-upon arrangement and store the deal in the deals database 139. A deal stored in the deals database 139 can include an identifier for seller, an identifier for a buyer, an identifier for the deal (“deal ID”), an identifier of an ad space inventory from the seller, and a floor price for an ad space in the ad space inventory. The floor price specifies a minimal bid price for the buyer. The deal can also include flight dates (start and ending dates for the deal), one or more user target segments, and an auction type. The auction type specifies whether the deal is private or public. For the private auction type, auctions for ad spaces of the deal are open only to buyers having agreements with the seller on the deal's corresponding ad space inventory. For the public auction type, auctions for ad spaces of the deal are open to every eligible buyer and not limiting to buyers having agreements with the seller on the deal's corresponding ad space inventory.

A buyer of a deal on an ad space inventory can set up a campaign targeting the ad space inventory with the deal's identifier and bid-specific information (e.g., the deal's floor bid price and user target segments) and store the deal's identifier and bid-specific information in the bid data databases 136. When receiving a bid request including the deal's identifier—i.e., a bid request for an ad space of the ad space inventory of the deal, a bidder (e.g., bidder B 152) can carry out the campaign on behalf of the buyer by accessing the bid-specific information stored in the bid data database 136 based on the deal's identifier, and generating a bid on the ad space based on the corresponding bid-specific information, for example.

Data associated with the ad space 126 can provide targeting information for buyers of the ad space 126, and can potentially command higher bid prices from buyers because of the targeting information. For instance, a grocery store advertiser may be willing to bid more on the ad space 126 if the user 119 is known for interests in food related topics (e.g., the user 119 has registered with a food website). As for another example, a sporting goods advertiser is more likely to bid more on the ad space 126 if the ad space 126 is part of a web page including a sports news article.

Data associated with the ad space 126 can include data associated with the user 119 such as user segment data and user behavioral data. User segment data include demographic information such as age, gender, location, school, and work. Other user segment data are possible. User behavioral data can include data associated with a user's online activities, for example, that the user put a toy in a shopping cart, the user searched for a toy, the user visited an online toy store yesterday, and a frequency the user searched for a toy. Other user behavioral data are possible.

Data associated with the ad space 126 can include contextual data of the user interface 124. For instance, contextual data can include type of the user interface 124 (e.g., a home page, a user interface of a game application), structure of the user interface 124 (e.g., a number of ads on the user interface 124), and content of the user interface 124 (e.g., game, finance, sports, travel, content not suitable for children). Other contextual data are possible.

User segment data such as demographic information can be provided by a user to a publisher when the user accesses websites or applications published by the publisher. User segment data such as location can also be determined by data associated with the user's client device (e.g., client device 120) such as an Internet Protocol (IP) address associated with the client device. User behavioral data can be collected by software executed by an application (e.g., application 125) on a user's client device (e.g., client device 120). Contextual data of a user interface (e.g., a web page presented by the client application 125) can be determined by analyzing content (e.g., words, semantics) presented in the user interface.

A buyer (or a seller) can acquire data associated with an ad space from the ad space's publisher or from a data provider (e.g., Proximic of Palo Alto, Calif.). In various implementations, the buyer (or the seller) can store user data in the server-side user data database 132. For instance, the buyer can store in the server-side user data database 132 mappings between user identifiers and user segments.

A buyer can acquire an ad space inventory from a publisher, combine the ad space inventory with data associated with the ad space inventory, and resell the ad space inventory to buyers for potentially higher prices because of the combined data (i.e., targeting information). For instance, a buyer can acquire an ad space inventory of a game application (e.g., ad spaces presented in user interfaces of the game application), combine with users (e.g., user identifiers) of a particular user segment (e.g., users younger than 30 years old), and resell the ad space inventory with the users of the particular user segment to advertisers targeting the particular user segment (e.g., an advertiser advertising headphones). However, the buyer (a reseller) in this case carries the risk of holding on the ad space inventory without being able to resell the ad inventory.

Particular implementations of the subject matter described in this specification describe methods for selling an ad space combined with data associated with the ad space, without acquiring the ad space in advance. In particular implementations, a seller (e.g., an ad network) can set up a deal (with one or more buyers) for an arrangement for purchasing a package that includes an ad space in an ad space inventory of a publisher and data associated with the ad space, and store the deal (for the package) in the deals database 139. The package deal (stored in the deals database 139) can include the package deal's identifier, and a floor bid price for the package. When an ad space in the ad space inventory becomes available, a buyer can bid on the package (including the ad space and data associated with the ad space) by submitting a bid using the package deal's identifier. In this way, the seller of the package deal does not acquire the ad space in advance before reselling the ad space (with the data included in the package) to the buyer. Particular implementations thus mitigate the risk for the seller of acquiring and holding on the ad space without reselling the ad space.

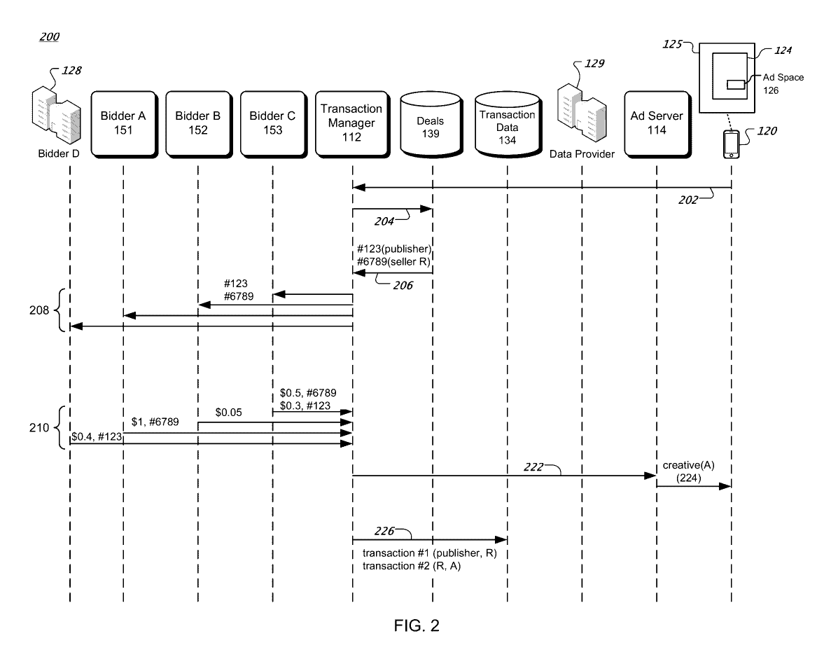

FIG. 2 is a data flow diagram of an example method for ad space auctions. For convenience of illustration, prices described hereon are based on the CPM pricing model. Other pricing models are possible. In FIG. 2, the transaction manager 112 receives an ad request (202) for an ad space 126 that is for presentation in the user interface 124. The ad space 126 is part of an ad space inventory of a publisher. In response to the ad request 202, the transaction manager 112 determines one or more deals that already exist for the ad space 126—e.g., deals for one or more ad space inventories that include the ad space 126. The transaction manager 112 can access the deals database 139 based on the ad space's identifier (204), and determines one or more existing deals (and respective deal IDs) for the ad space 126 (206). By way of illustration, assume that there are two existing deals for the ad space 126. The first deal (with a deal ID #123) has a floor price of $0.10 for purchasing the ad space 126 from the publisher of the ad space 126. The second deal (with an deal ID #6789) has a floor price of $0.25 for purchasing from a seller R a package including the ad space 126 and data associated with the ad space 126. For instance, the seller R can be an ad network or another publisher. Data associated with the ad space 126 can be a user segment (e.g., men between 20 and 40 years old) for the user 119.

The transaction manager 112 sends to multiple bidders a bid request (208) requesting a bid on the ad space 126. The bid request 208 includes an identifier of the ad space 126, a size of the ad space 126, and identifiers of existing deals (deal IDs #123 and #6789) on the ad space 126. As described earlier, the bid request 208 can be composed in JSON format and transmitted to bidders using HTTP POST. Other bid request formats and transmission methods are possible.

By way of illustration, the transaction manager 112 receives respective bids (in response to the bid request 208) from the bidder A, bidder B, bidder C, and bidder D (210). Each bid includes a bid price, an identifier of a buyer, and an identifier of a creative from the buyer. A bid can also include a deal ID indicating bidding based on a corresponding deal. Here, assume that bidder A (e.g., representing buyer A) submits a bid price of $1.00 on the package, as indicated by the deal ID #6789. Bidder B (e.g., representing buyer B) submits a bid price of $0.05 on the ad space 126, without including a deal for the bid. Bidder C (e.g., representing buyer C) submits a bid price of $0.50 on the package (as indicated by the deal ID #6789), and another bid price of $0.30 on the ad space 126 (using the deal ID #123). Bidder D (e.g., representing buyer D) submits a bit price of $0.40 on the ad space 126 (using the deal ID #123).

From the received bids, the transaction manager 112 selects a winning bid based on bid prices and floor prices set by the existing deals. For instance, the transaction manager 112 determines that the $1.00 bid price on the package from the buyer A is the highest bid price among received bids, and satisfies the $0.25 floor price of the deal #6789, and then selects the $1.00 bid on the package from the buyer A as the winning bid.

After selecting the bid from the buyer A as the winning bid, the transaction manager 112 sends to the ad server 114 a message including the identifier of the ad space 126 and the identifier of the creative from buyer A (222). The ad server 114 then provides to the client device 120 the creative from buyer A for presentation in the ad space 126 (224).

The transaction manager 112 also stores in the transaction data database 134 records for two transactions (226). The first transaction is between the publisher of the ad space 126 and the seller R. In the first transaction, the seller R buys the ad space 126 from the publisher of the ad space 126. The second transaction is between the seller R and the buyer A. In the second transaction, the buyer A buys from the seller R the package including the ad space 126 and the data associated with the ad space based on the deal #6789. That is, the seller R buys the ad space 126 from the publisher through the first transaction, and resells the ad space 126 (with the additional data associated with the ad space 126) to the buyer A through the second transaction. Since the transaction manager 112 conducts the auction on the ad space 126 and records the first and second transactions for the auction at the same time, the seller R resells the ad space 126 with the additional data using the package deal #6789 in one auction, without having possession of the ad space 126 at any time.

The transaction manager 112 can determine respective transaction prices for the first and second transactions and store the transaction prices in the transaction data database 134. The transaction manager 112 can determine the transaction prices based on the selected bid's bid price ($1.00). By way of illustration, assume that the seller R (a reseller of the ad space 126) can take a 10% gross margin through the package deal $6789. Assume that the transaction manager 112 conducts the auction on the ad space 126 using a second-price auction mechanism. In the example of FIG. 2, the second-highest bid price among the received bids is the $0.50 bid price from the buyer C. The transaction manager 134 can assign the $0.50 second-highest bid price as the first transaction price that is payable to the publisher of the ad space 126 by the seller R. By applying the 10% gross margin, the transaction manager 134 can determine that the second transaction price payable to the seller R by the buyer A is $0.56 (=$0.50/90%). That is, the seller R gains a 10% or $0.06 margin by reselling the ad space 126 with the $0.56 sale price and the of $0.50 cost. In various implementations, the transaction manager 112 can apply a service fee to the buyer A. For instance, the transaction manager 112 can charge the buyer a 10% fee of $0.06 (=$0.56/90%−$0.56) by recording (in the transaction data database 134) a third transaction including the $0.06 fee that is payable by the buyer A to the service provider of the server system 122.

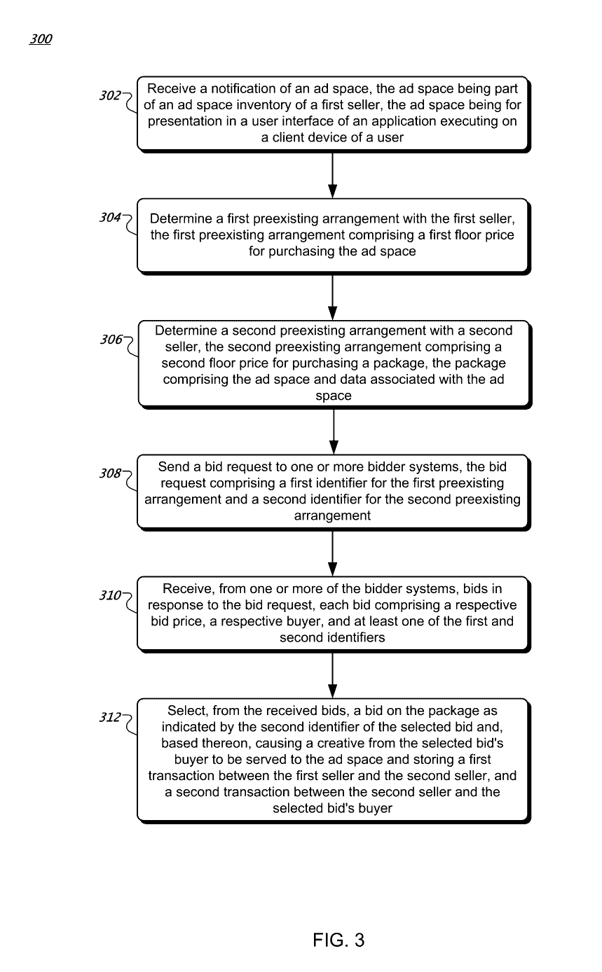

FIG. 3 is a flowchart of another example method for ad space auctions. The method can be implemented using software components executing on one or more data processing apparatus that are part of the data center 121 described earlier. For instance, the method can be implemented using the transaction manager 112. The method begins by receiving a notification of an ad space, the ad space being part of an ad space inventory of a first seller, the ad space being for presentation in a user interface of an application executing on a client device of a user (302). The method determines a first preexisting arrangement with the first seller, the first preexisting arrangement comprising a first floor price for purchasing the ad space (304). The method determines a second preexisting arrangement with a second seller, the second preexisting arrangement comprising a second floor price for purchasing a package, the package comprising the ad space and data associated with the ad space (306). The method sends a bid request to one or more bidder systems, the bid request comprising a first identifier for the first preexisting arrangement and a second identifier for the second preexisting arrangement (308). The method receives, from one or more of the bidder systems, bids in response to the bid request, each bid comprising a respective bid price, a respective buyer, and at least one of the first and second identifiers (310). The method selects, from the received bids, a bid on the package as indicated by the second identifier of the selected bid and, based thereon, causing a creative from the selected bid's buyer to be served to the ad space and storing a first transaction between the first seller and the second seller, and a second transaction between the second seller and the selected bid's buyer (312).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
performed by an auction system:
receiving a notification of an ad space, the ad space being part of an ad space inventory of a first seller, the ad space being for presentation in a user interface of an application executing on a client device of a user;
determining a first preexisting arrangement with the first seller, the first preexisting arrangement comprising a first floor price for purchasing the ad space;
determining a second preexisting arrangement with a second seller, the second preexisting arrangement comprising a second floor price for purchasing a package, the package comprising the ad space and data associated with the ad space;
sending a bid request to one or more bidder systems, the bid request comprising a first identifier for the first preexisting arrangement and a second identifier for the second preexisting arrangement;
receiving, from one or more of the bidder systems, bids in response to the bid request, each bid comprising a respective bid price, a respective buyer, and at least one of the first and second identifiers; and
selecting, from the received bids, a bid on the package as indicated by the second identifier of the selected bid and, based thereon, causing a creative from the selected bid's buyer to be served to the ad space and storing:
a first transaction between the first seller and the second seller; and
a second transaction between the second seller and the selected bid's buyer.

2. The method of claim 1, wherein the first transaction further comprises a first transaction price payable to the first seller by the second seller, the first transaction price being based on the selected bid's bid price.

3. The method of claim 1, wherein the second transaction further comprises a second transaction price payable to the second seller by the selected bid's buyer, the second transaction price being based on the selected bid's bid price.

4. The method of claim 1, wherein the selected bid's bid price satisfies the second floor price.

5. The method of claim 1, wherein the data associated with the ad space comprises data associated with the user.

6. The method of claim 5, wherein the data associated with the user comprises user segment data or user behavioral data.

7. The method of claim 1, wherein the data associated with the ad space comprises contextual data of the user interface.

8. The method of claim 1, wherein the bid request further comprises at least one of an identifier of the ad space, a size of the ad space, an identifier of the application or a web page including the ad space, an identifier of the user, and an identifier of the client device.

9. A system comprising:
one or more computers programmed to perform operations comprising:
receiving a notification of an ad space, the ad space being part of an ad space inventory of a first seller, the ad space being for presentation in a user interface of an application executing on a client device of a user;
determining a first preexisting arrangement with the first seller, the first preexisting arrangement comprising a first floor price for purchasing the ad space;
determining a second preexisting arrangement with a second seller, the second preexisting arrangement comprising a second floor price for purchasing a package, the package comprising the ad space and data associated with the ad space;
sending a bid request to one or more bidder systems, the bid request comprising a first identifier for the first preexisting arrangement and a second identifier for the second preexisting arrangement;
receiving, from one or more of the bidder systems, bids in response to the bid request, each bid comprising a respective bid price, a respective buyer, and at least one of the first and second identifiers; and
selecting, from the received bids, a bid on the package as indicated by the second identifier of the selected bid and, based thereon, causing a creative from the selected bid's buyer to be served to the ad space and storing:
a first transaction between the first seller and the second seller; and
a second transaction between the second seller and the selected bid's buyer.

10. The system of claim 9, wherein the first transaction further comprises a first transaction price payable to the first seller by the second seller, the first transaction price being based on the selected bid's bid price.

11. The system of claim 9, wherein the second transaction further comprises a second transaction price payable to the second seller by the selected bid's buyer, the second transaction price being based on the selected bid's bid price.

12. The system of claim 9, wherein the selected bid's bid price satisfies the second floor price.

13. The system of claim 9, wherein the data associated with the ad space comprises data associated with the user.

14. The system of claim 13, wherein the data associated with the user comprises user segment data or user behavioral data.

15. The system of claim 9, wherein the data associated with the ad space comprises contextual data of the user interface.

16. The system of claim 9, wherein the bid request further comprises at least one of an identifier of the ad space, a size of the ad space, an identifier of the application or a web page including the ad space, an identifier of the user, and an identifier of the client device.

17. A storage device having instructions stored thereon that when executed by one or more computers perform operations comprising:
receiving a notification of an ad space, the ad space being part of an ad space inventory of a first seller, the ad space being for presentation in a user interface of an application executing on a client device of a user;
determining a first preexisting arrangement with the first seller, the first preexisting arrangement comprising a first floor price for purchasing the ad space;
determining a second preexisting arrangement with a second seller, the second preexisting arrangement comprising a second floor price for purchasing a package, the package comprising the ad space and data associated with the ad space;
sending a bid request to one or more bidder systems, the bid request comprising a first identifier for the first preexisting arrangement and a second identifier for the second preexisting arrangement;
receiving, from one or more of the bidder systems, bids in response to the bid request, each bid comprising a respective bid price, a respective buyer, and at least one of the first and second identifiers; and
selecting, from the received bids, a bid on the package as indicated by the second identifier of the selected bid and, based thereon, causing a creative from the selected bid's buyer to be served to the ad space and storing:
a first transaction between the first seller and the second seller; and
a second transaction between the second seller and the selected bid's buyer.

18. The storage device of claim 17, wherein the first transaction further comprises a first transaction price payable to the first seller by the second seller, the first transaction price being based on the selected bid's bid price.

19. The storage device of claim 17, wherein the second transaction further comprises a second transaction price payable to the second seller by the selected bid's buyer, the second transaction price being based on the selected bid's bid price.

20. The storage device of claim 17, wherein the selected bid's bid price satisfies the second floor price.
